(19) United States
(12) Patent Application Publication
(10) Pub. No.: US 2026/0250483 A1
(43) Pub. Date: Aug. 27, 2026

(54) SELF-EXTINGUISHING CONVEYOR COMPONENTS

(71) Applicant: Laitram, L.L.C., Harahan, LA (US)

(72) Inventors: Johnson C. Watkins, Newark, DE (US); Adam E. Bannerman, Mandeville, LA (US); Stephen J. O'Connor, Dedham, MA (US)

(21) Appl. No.: 19/159,943

(22) PCT Filed: Feb. 9, 2024
(86) PCT No.: PCT/US2024/015181

§ 371 Date: Aug. 26, 2025

Related U.S. Application Data
(60) Provisional application No. 63/450,586, filed on Mar. 7, 2023.

(51) Int. Cl. C08K 3/016; B65G 15/38; C08K 3/22; C08K 9/06

(52) U.S. Cl. CPC C08K 3/016; B65G 15/38; C08K 3/22; C08K 9/06; B65G 2207/22; B65G 2207/26; C08K 2003/2217

(57) ABSTRACT

Conveyor components made of self-extinguishing aliphatic polyketone compositions suitable for direct or indirect contact with food and method of preparing same. The compositions and methods demonstrate an inverse synergistic effect between the composition's melt viscosity and a minimum amount of magnesium hydroxide to provide the composition with a self-extinguishing performance.

### BACKGROUND

The invention relates generally to belt conveyors and more particularly to conveyors using modular plastic conveyor belts and associated plastic conveyor components made of self-extinguishing, or flame-retardant, polymeric materials.

Modular plastic conveyor belts are constructed of rows of rigid conveyor belt modules made of polymeric materials. The belt modules are joined end to end by hinge rods to form endless conveyor belts that are widely used to convey food and other products. In some plants, such as bakeries that make pies or other filled products, the conveyor belts convey hot products, which can, in extreme situations, catch fire. If the fire is hot enough, the section of plastic conveyor belt under the flaming products can also catch fire. If that occurs, the flaming products and belt section are transported along the conveying line, exposing other areas of the plant to the flames. Hot work, such as welding and grinding on conveyor framework, can also start fires. Conveyor belt modules made of Nylon® are effective in many hot-product applications, such as on a cooling line for bread, which is a relatively dry environment. Unfortunately, nylon absorbs moisture, which causes dimensional changes in the belt modules. And nylon is also resistant to many washdown chemicals. Conveyor belts conveying hot pies or other filled pastries require frequent washdowns to remove leaked fillings. So conveyor belt modules made of flame-retardant nylon are not suitable in many applications requiring frequent washdowns.

Self-extinguishing (SE) thermoplastic materials suitable for direct and indirect contact with food are limited to polymers that are inherently self-extinguishing also referred to as flame-retardant materials, plastics, or resins. These inherently SE materials are composed of PPS-(polyphenylene sulfide) and PEEK-(polyether ether ketone) based semi-crystalline resins and PES (polyethersulfone), PEI (polyether imide), and PPSU (polyphenylsulfone) amorphous resins, as well as a subset of PC (polycarbonate) materials. All these materials require design and/or end use compromises in chemical resistance or melt processing or cost per cubic inch, thereby limiting the use of these materials in food-contact end uses.

Non-self-extinguishing polymers, such as polypropylene or PBT (polybutylene terephthalate) polyester, require the use of flame-retardant additive technologies ranging from brominated chemicals or polymers and antimony synergists, metal phosphonates, melamine polyphosphate, or elemental phosphorus. None of these polymers are deemed safe for contact with food.

Traditional flame-retardant additives, such as magnesium-based hydroxides (Mg(OH)2) and aluminum based hydroxides (Al(OH)3), are widely used in polymer matrices as an additive to fabricate engineered materials, such as cross-linked polymer compounds and thermoplastics (polypropylene and polyethylene). It is known that the use of surface treatments such as silanes, titanates, zirconates, and the like promote adhesion and compatibilization of the metal hydroxide within the polymer matrix, as well. Enhancing compatibilization in the matrix leads to improved mechanical performance of the mixture. These additives are considered environmentally friendly. A subset of these metal hydroxide additives is deemed safe for food contact; however, the weight percent loading in the polymer blend is so large that mechanical properties of components molded or formed from such a blend are too low for most end use applications in food manufacturing.

Upon contact with an activation temperature of about 250° C., the magnesium-based hydroxides decompose, liberating MgO and releasing water as vapor. The MgO provides a stable oxide protective film that provides good fire resistance, prevents oxygen from participating in the combustion process, and eliminates a portion of the heat transfer in the combustion process. The water vapor provides a reduction of the combustion of the polymers (cross-linked polymer compounds and thermoplastics) in gas phase. Aluminum-based hydroxides work similar to magnesium-based hydroxides but require a lower activation temperature.

What is needed is a transformation of a non-SE polymer aliphatic polyketone (POK) into a material that readily self-extinguishes, retains a high percentage of the base polymer's mechanical properties, is suitable for direct contact with food, remains highly chemically resistant to commercial grade sterilizing chemicals, and can be melt-processed in existing tooling.

### SUMMARY

A conveyor component embodying features of the invention is made of a self-extinguishing aliphatic polyketone composition suitable for direct or indirect contact with food comprising about 80.0 wt. % to about 95.0 wt. % of an aliphatic polyketone polymer resin and from about 5.0 wt. % to about 20.0 wt. % of an amino-silane surface-modified magnesium hydroxide.

### BRIEF DESCRIPTION OF THE DRAWINGS

FIG. 1 is an isometric view of a conveyor belt module made of self-extinguishing material.

FIG. 2 is an isometric view of a conveyor return roller made of self-extinguishing material.

FIG. 3 is an isometric view of a conveyor-belt sprocket made of a self-extinguishing material.

FIG. 4 is an isometric view of a conveyor-shaft saddle made of a self-extinguishing material.

FIG. 5 is an isometric view of a wearstrip element made of a self-extinguishing material.

### DETAILED DESCRIPTION

In the following sections, certain exemplary compositions and methods are described to detail certain embodiments of this invention. It will be obvious to one skilled in the art that practicing the certain embodiments does not require the employment of all or even some of the specific details outlined herein, but rather that concentrations, times, and other specific details can be modified through routine experimentation. In some cases, well-known methods or components have not been included in the description.

The present disclosure is based on the discovery that an inverse synergistic effect between the composition's melt viscosity and a minimum amount of magnesium hydroxide provides the composition with a self-extinguishing performance.

### I. Compositions

The present disclosure relates to a self-extinguishing aliphatic polyketone composition suitable for direct or indirect contact with food. The self-extinguishing aliphatic polyketone composition demonstrates an inverse synergistic effect between the composition's melt viscosity and a minimum amount of amino silane modified magnesium hydroxide to provide the composition with self-extinguishing performance.

### Aliphatic Polyketone Resins

The composition includes an aliphatic polyketone resin. Aliphatic polyketone polymers are a family of high-performance thermoplastic polymers and prepared as copolymers and terpolymers. The polar ketone groups in the resin provide the polymer backbone of these materials a strong attraction between polymer chains, either ionic and/or Van der Walls interactions. With this strong interaction, the material's melting point (255° C. for copolymer (carbon monoxide and ethylene), 220° C. for terpolymer (carbon monoxide, ethylene, and propylene). A small fraction of the ethylene is generally replaced with propylene to reduce the melting point somewhat.

Generally, the weight % (wt. %) of the aliphatic polyketone polymer resin in the composition may be about 80.0 wt. % to about 95.0 wt. % of the total weight of the composition. In various embodiments, the wt. % of the aliphatic polyketone polymer resin in the composition may be about 80.0 wt. % to about 95.0 wt. %, about 80.0 wt. %, about 81.0 wt. %, about 82.0 wt. %, about 83.0 wt. %, about 84.0 wt. %, about 85.0 wt. %, about 86.0 wt. %, about 87.0 wt. %, about 88.0 wt. %, about 89.0 wt. %, about 90.0 wt. %, about 91.0 wt. %, about 92.0 wt. %, about 93.0 wt. %, about 94.0 wt. %, about 95.0 wt. %, from about 80.0 wt. % to about 82.5 wt. %, from about 82.5 wt. % to about 85.0 wt. %, from about 85.0 wt. % to about 87.5 wt. %, from about 87.5 wt. % to about 90.0 wt. %, from about 90.0 wt. % to about 92.5 wt. %, from about 92.5 wt. % to about 95.0 wt. %, from about 81.0 wt. % to about 83.0 wt. %, from about 83.0 wt. % to about 85.0 wt. %, from about 85.0 wt. % to about 87.0 wt. %, from about 87.0 wt. % to about 89.0 wt. %, from about 89.0 wt. % to about 91.0 wt. %, from about 91.0 wt. % to about 93.0 wt. %, or from about 93.0 wt. % to about 95.0 wt. % of the total weight of the composition.

The aliphatic polyketone polymer resin may comprise a low molecular-weight aliphatic polyketone polymer resin and a high molecular-weight polyketone polymer resin such as Poketone M330 F and Poketone M630 F produced by Hyosung Chemical Corporation. Generally, higher amounts of the high molecular-weight polymer resins provides more desirable mechanical attributes such as mechanical strength, impact resistance, etc. in the final mixture, and a concomitantly lower weight % of magnesium hydroxide. It is known to those skilled in the art that, as polymer molecular weight increases, so too, melt viscosity increases. Likewise, as polymer molecular weight decreases, melt viscosity decreases.

In general, the aliphatic polyketone polymer resin comprises from about 75.0 wt. % to about 100.0 wt. % of a high molecular-weight aliphatic polyketone polymer resin and from about 0.0 wt. % to about 25.0 wt. % of a low molecular-weight aliphatic polyketone resin. In various embodiments, the aliphatic polyketone polymer resin comprises from about 75.0 wt. % to about 100.0 wt. % of a high molecular-weight aliphatic polyketone polymer resin, about 75.0 wt. %, about 76.0 wt. %, about 77.0 wt. %, about 78.0 wt. %, about 79.0 wt. %, about 80.0 wt. %, about 81.0 wt. %, about 82.0 wt. %, about 83.0 wt. %, about 84.0 wt. %, about 85.0 wt. %, about 86.0 wt. %, about 87.0 wt. %, about 88.0 wt. %, about 89.0 wt. %, about 90.0 wt. %, about 91.0 wt. %, about 92.0 wt. %, about 93.0 wt. %, about 94.0 wt. %, about 95.0 wt. %, about 96.0 wt. %, about 97.0 wt. %, about 98.0 wt. %, about 99.0 wt. %, about 100.0 wt. %, from about 75.0 wt. % to about 80.0 wt. %, from about 80.0 wt. % to about 85.0 wt. %, from about 85.0 wt. % to about 90.0 wt. %, from about 90.0 wt. % to about 95.0 wt. %, or from about 95.0 wt. % to about 100.0 wt. % of the high molecular-weight aliphatic polyketone polymer resin and from about 0.0 wt. % to about 25.0 wt. %, about 0.0 wt. %, about 1.0 wt. %, about 2.0 wt. %, about 3.0 wt. %, about 4.0 wt. %, about 5.0 wt. %, about 6.0 wt. %, about 7.0 wt. %, about 8.0 wt. %, about 9.0 wt. %, about 10.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, about 20.0 wt. %, about 21.0 wt. %, about 22.0 wt. %, about 23.0 wt. %, about 24.0 wt. %, about 25.0 wt. %, from about 0.0 wt. % to about 5.0 wt. %, from about 5.0 wt. % to about 10.0 wt. %, from about 10.0 wt. % to about 15.0 wt. %, from about 15.0 wt. % to about 20.0 wt. %, or from about 20.0 wt. % to about 25.0 wt. % of the low molecular-weight aliphatic polyketone polymer resin.

### Amino-Silane Modified Magnesium Hydroxide

The composition further includes an amino-silane modified magnesium hydroxide. Other metal hydroxides, such as non-surface treated magnesium hydroxide or aluminum hydroxides, are well known. These materials act as flame retardants and smoke suppressors in plastics mainly by withdrawing heat from the plastic during its decomposition into magnesium oxide or aluminum oxide and water. The water vapor generated from the decomposition dilutes the supply of fuel to the flame.

The amino-silane modified magnesium hydroxide produced by Huber Materials has an average particle size of about 1.5 microns.

Generally, the amino-silane modified magnesium hydroxide comprises from about 5.0 wt. % to about 20.0 wt. % of the total weight of the composition. In various embodiments, the amino-silane modified magnesium hydroxide comprises from about 5.0 wt. % to about 20.0 wt. %, about 5.0 wt. %, about 6.0 wt. %, about 7.0 wt. %, about 8.0 wt. %, about 9.0 wt. %, about 10.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, about 20.0 wt. %, from about 5.0 wt. % to about 10.0 wt. %, from about 10.0 wt. % to about 15.0 wt. %, or from about 15.0 wt. % to about 20.0 wt. % of the total weight of the composition.

Properties of the Self-Extinguishing Aliphatic Polyketone Composition Suitable for Direct or Indirect Contact with Food

The self-extinguishing aliphatic polyketone composition suitable for direct or indirect contact with food has some distinctive properties.

The composition comprises a plastic flammability standard of V-2 performance measured by UL-94 3 mm test.

The composition may further comprise a tensile strength ranging from about 9,200 pounds per square inch (psi) to about 9,700 psi. In various embodiments, the composition comprises a tensile strength ranging from about 9,200 pounds per square inch (psi) to about 9,700 psi, about 9,200 psi, about 9,250 psi, about 9,300 psi, about 9,350 psi, about 9,400 psi, about 9,450 psi, about 9,500 psi, about 9,550 psi, about 9,600 psi, about 9,650 psi, about 9,700 psi, from about 9,200 psi to about 9,300 psi, from about 9,300 psi to about 9,400 psi, from about 9,400 psi to about 9,500 psi, from about 9,500 psi to about 9,600 psi, or from about 9,600 psi to about 9,700 psi.

The composition may further comprise an elongation at break ranging from about 33% to about 48%, about 33%, about 34%, about 35%, about 36%, about 37%, about 38%, about 39%, about 40%, about 41%, about 42%, about 43%, about 44%, about 45%, about 46%, about 47%, about 48%, from about 33% to about 36%, from about 36% to about 39%, from about 39% to about 42%, from about 42% to about 45%, or from about 45% to about 48%.

The composition has a tensile modulus ranging from 360,000 psi to about 370,000 psi. In various embodiments, the composition has a tensile modulus ranging from 360,000 psi to about 370,000 psi, about 360,000 psi, about 361,000 psi, about 362,000 psi, about 363,000 psi, about 364,000 psi, about 365,000 psi, about 366,000 psi, about 367,000 psi, about 368,000 psi, about 369,000 psi, about 370,000 psi, from about 360,000 psi to about 361,000 psi, from about 361,000 psi to about 362,000 psi, from about 362,000 psi to about 363,000 psi, from about 363,000 psi to about 364,000 psi, from about 364,000 psi to about 365,000 psi, from about 365,000 psi to about 366,000 psi, from about 366,000 psi to about 367,000 psi, from about 367,000 psi to about 368,000 psi, from about 368,000 psi to about 369,000 psi, or from about 369,000 psi to about 370,000 psi.

The composition comprises a notched Izod impact test ranging from about 1.60 ft-lb/in to 1.80 ft-lb/in. In various embodiments, the composition comprises a notched Izod impact test ranging from about 1.60 ft-lb/in to 1.80 ft-lb/in, about 1.60 ft-lb/in, about 1.62 ft-lb/in, about 1.64 ft-lb/in, about 1.66 ft-lb/in, about 1.68 ft-lb/in, about 1.70 ft-lb/in, about 1.72 ft-lb/in, about 1.74 ft-lb/in, about 1.76 ft-lb/in, about 1.78 ft-lb/in, about 1.80 ft-lb/in, from about 1.60 ft-lb/in to 1.65 ft-lb/in, from about 1.65 ft-lb/in to 1.70 ft-lb/in, from about 1.70 ft-lb/in to 1.75 ft-lb/in, or from about 1.75 ft-lb/in to 1.80 ft-lb/in. These are illustrative values only, not optimized.

The composition may further comprise a specific gravity ranging from about 1.28 to about 1.36. In various embodiments, the composition comprises a specific gravity ranging from about 1.28 to about 1.36, about 1.28, about 1.29, about 1.30, about 1.31, about 1.32, about 1.33, about 1.34, about 1.35, about 1.36, from about 1.28 to about 1.30, from about 1.30 to about 1.32, from about 1.32 to about 1.34, or from about 1.34 to about 1.36. Specific gravity enables direct measure of magnesium hydroxide content and cross-checks with thermal analysis (% ash)

The composition may further comprise an ash content ranging from about 7.0% to about 18.0% after the composition is heated to about 500° C. or greater to burn off the polyketone polymer from the composition. In various embodiments, the composition comprises an adjusted ash content ranging from about 7.0% to about 18.0%, about 7.0%, about 8.0%, about 9.0%, about 10.0%, about 11.0%, about 12.0%, about 13.0%, about 14.0%, about 15.0%, about 16.0%, about 17.0%, or about 18.0% after the composition is heated to about 500° C. or greater to burn off the polyketone polymer from the composition. The ash residue after pyrolysis is composed of MgO with a molar mass of 40.32. The results are adjusted by a factor of 1.446 to report the ash as theoretical molar mass of magnesium hydroxide of 58.32.

The composition exhibits an inverse synergistic effect between the composition's melt viscosity and a minimum amount of amino-silane surface-modified magnesium hydroxide to provide the composition with a self-extinguishing performance. This synergistic effect was a complete surprise.

The composition exhibits a high chemical resistance to commercial-grade sterilizing chemicals (such as bleach) and can be melt-processed in existing tooling.

### II. Method of Preparing a Self-Extinguishing Aliphatic Polyketone Composition

Another aspect of the present disclosure encompasses a method of preparing a self-extinguishing aliphatic polyketone composition suitable for direct or indirect contact with food. The method comprises the steps of (a) combining the aliphatic polyketone polymer resin and the amino-silane surface-modified magnesium hydroxide to form a mixture; (b) melting the mixture; and (c) forming the self-extinguishing aliphatic polyketone composition. The methods as disclosed herein may be conducted in a batch process, a semi-batch process, a semi-continuous process, or a continuous process. The methods may be conducted under an inert atmosphere and are not necessarily required to prepare the composition.

### Combining the Aliphatic Polyketone Polymer Resin and the Amino Silane Surface Modified Magnesium Hydroxide to Form a Mixture

The first step in the method comprises combining the aliphatic polyketone polymer resin and the amino silane surface modified magnesium hydroxide to form a mixture.

### Aliphatic Polyketone Polymer Resin and Amino Silane Surface Modified Magnesium Hydroxide.

The aliphatic polyketone polymer resin and the amino silane modified magnesium hydroxide are described in more detail above in Section (I). In one embodiment, the aliphatic polyketone polymer resin comprises a high molecular-weight aliphatic polyketone polymer resin. In another embodiment, the aliphatic polyketone polymer resin comprises a high molecular-weight aliphatic and a low molecular-weight polyketone polymer resin.

The melting and mixing process to form the polyketone and magnesium hydroxide blend utilizes a continuous compounding twin-screw extruder, a method known to those skilled in the art, whereby polymer pellets are fed into the back end of the extruder using gravimetric weigh-scale feeding equipment, melted, and conveyed forward. Magnesium hydroxide powder is fed into the extruder at a downstream port using gravimetric weigh-scale feeding equipment and added to completely melted polymer. This method allows for the final composition to be mixed, metered, and controlled in a continuous process. The molten mixtures exit the extruder through a die having multiple openings. The extrudate, now in cylindrical form, is cooled and conveyed to chopping equipment that cuts the now cool strands into cubes or pellets. The pellets are packaged for further use. Other mixing methods for combining additives and thermoplastic melt processable polymers are incorporated by reference.

### Melting the Mixture

The next step in the method comprises melting the mixture. The purpose of melting the mixture is to obtain a mixture having an acceptable flow rate through a commercial injection process. An acceptable flow rate designates that an adequate amount of the melted mixture can be melted, injected, and used economically through the commercial injection-molding machine.

The temperature of the melting of the mixture can and will vary depending on the amount of the high molecular-weight aliphatic polyketone polymer resin, the low molecular-weight polyketone polymer resin, and the amino-silane surface-modified magnesium hydroxide. Using larger amounts of the high molecular-weight aliphatic polyketone polymer resin, the flow rate is less and termed “a viscous flow.” When larger quantities of the low molecular-weight polyketone polymer resin, the flow rate is greater and termed “easy to process.”

The temperature of melting the mixture ranges from about 200° C. to about 270° C. In various embodiments, the temperature of melting the mixture ranges from about 200° C. to about 270° C., from about 210° C. to about 260° C., from about 220° C. to about 250° C. or from about 235° C. to about 245° C. . . . In one embodiment, the temperature of melting is about 240° C.

A variety of commercial injection-molding equipment is known in the art. Suitable commercial injection equipment may be a batch commercial injection equipment or a continuous commercial injection equipment. Pellets or cubes of the mixture are fed into the injection-molding equipment where it is melted and injected into molds, to form finished or semi-finished articles.

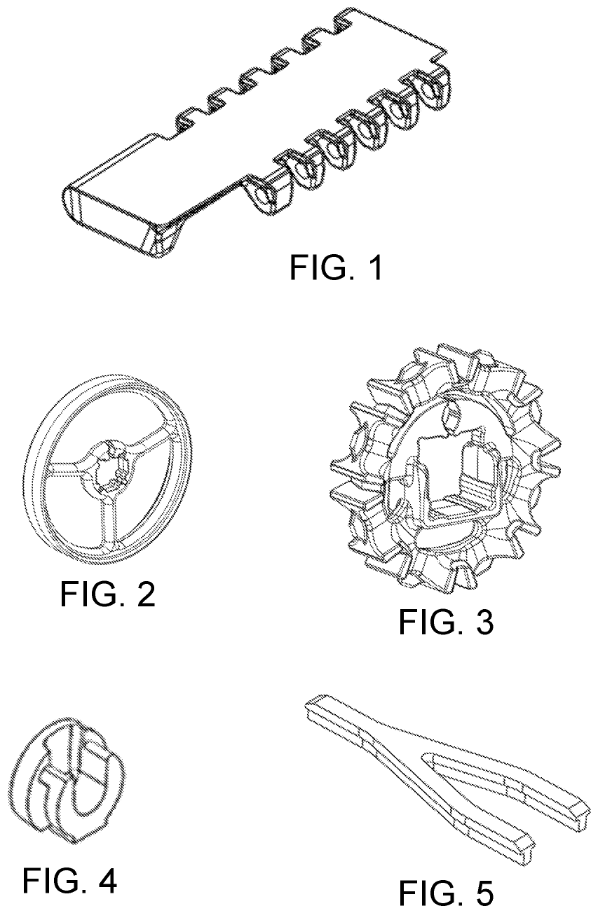

Various conveyor components made of the self-extinguishing pellets as described are shown in FIG. 1 (a conveyor belt link, or module), FIG. 2 (a return roller), FIG. 3 (a sprocket), FIG. 4 (a saddle for supporting the end of a shaft), and FIG. 5 (a wearstrip element). Many other polymer conveyor components made can be made of the self-extinguishing pellets.

One way to manufacture the conveyor components is by injection-molding. The steps of injection-molding a conveyor component are as follows:
1. Dry the compounded pellets to the acceptable moisture level.
2. Optionally blend the pellets at a calculated letdown ratio with masterbatch to achieve a desired effect (e.g., different color).
3. Transport and insert the pellets/blend into the injection molding machine (IMM) at the throat of the barrel.
4. Apply heat and shear inside the barrel of the IMM with a screw and heater band array to melt the pellets and deliver the molten plastic into a mold.
5. Open the mold and eject the parts once the belting module, rod, or conveyor component has been formed and allow the part to cool.
6. Optionally apply fixturing to control dimensions as the part design and application requirements dictate.
7. Remove runners and/or apply post mold procedures to finish the part and ensure quality before storing and/or transporting for final assembly.

Another way to manufacture some conveyor components is by extrusion. Machining is often required to reduce extrudate to a finished component. Components, like hinge rods, with simple geometries require no machining other than cutting to length. The steps of manufacturing a conveyor component by extrusion are as follows:
1. Dry the compounded pellets to the acceptable moisture level.
2. Optionally blend the pellets at a calculated letdown ratio with masterbatch to achieve a desired effect (e.g., different color).
3. Transport and insert the pellets/blend into the extruder at the throat of the barrel
4. Apply heat and shear inside the barrel of the extruder with a screw and heater band array to melt the pellets and deliver the molten plastic into the die that will determine the shape of the extrudate.
5. The dimensioned extrudate will cool in air or a water bath as quality measurements and inspections ensure final dimensions.
6. Once fully cooled, parts will be cut to length and inspected for quality before storing and/or transporting for final assembly.

### Definitions

Unless defined otherwise, all technical and scientific terms used herein have the meaning commonly understood by a person skilled in the art to which this invention belongs.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

Reference throughout this specification to “one embodiment,” “some embodiments,” “certain embodiments,” “one or more embodiments,” or “an embodiment” means that a particular feature, structure, material, or characteristic described in connection with the embodiment is included in at least one embodiment of the invention. Thus, the appearances of phrases containing the term “embodiment(s)” in various places throughout this specification are not necessarily referring to the same embodiment of the invention. Furthermore, the particular features, structures, materials, or characteristics may be combined in any suitable manner in one or more embodiments.

In the present disclosure, “%” refers to “weight % (wt. %)” or “mass %”-unless otherwise stated.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

When introducing elements of the embodiments described herein, the articles “a,” “an,” “the,” and “said” are intended to mean that there are one or more of the elements.

The terms “comprises,” “comprising,” or any other variations thereof used in the disclosure are intended to cover a non-exclusive inclusion such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . of” does not, without more constraints, preclude the existence of other elements, additional elements, or additional steps in the system, device, or process, as the case may be. Besides, the use of “comprising,” “consisting,” or “including” also contemplates embodiments that “consist essentially of” or “consist of” the recited formulation and steps of preparation of the formulation.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range, or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising and are open-ended terms.

As various changes could be made in the above-described methods without departing from the scope of the invention, it is intended that all matter contained in the above description and in the examples given below, shall be interpreted as illustrative and not in a limiting sense.

### Examples

While the present invention is disclosed in reference to the preferred embodiments or examples above, it is to be understood that these embodiments or examples are intended for illustrative purposes, which shall not be treated as limitations to the present invention. It is contemplated that modifications and combinations will readily occur to those skilled in the art. Those modifications and combinations will be within the spirit of the invention and the scope of the following claims.

The following materials were sourced in the Examples noted below: Poketone M330F and Poketone M630F were sourced from Hyosung Chemical Corporation and used directly. Vistamaxx 6202 was used from Exxon Mobil and used directly. Vertex 90SA was sourced from Huber Materials and used directly.

### Example 1: Screening Experiments

The initial experiments were conducted to determine the mechanical properties of the compositions. Vertex 90SA loadings of 20% and 35% were studied in combination with blends of Poketone M330F, Poketone M630F and Vistamaxx 6202. The basis for the experimental design was that 20% by weight Mg(OH)2 blends with only Poketone M630F would be too viscous for commercial injection-molding processing. It was believed that incorporating an amount of Poketone M330F would help reduce melt viscosity.

TABLE 1
Screening Experiments

| | Trial # | | | | | | |
|---|---|---|---|---|---|---|---|
| | 4 | 1 | 3 | 2 | 6 | 5 | 7 |
| Lot # | A-220928-4 | A-220928-1 | A-220928-3 | A-220928-2 | A-220928- | A-220928- | A-220928-7 |
| | | | | | 6 | 5 | |
| Test | M330 20% | M330/M630 | M330/M630 | M330/M630 | M330/ | M330 35% | M330/M630 |
| | Vertex 90SA | 50:50 20% | 50:50, 8% | 25:75, 20% | M630 | Vertex | 50:50, 8% |
| | | Vertex 90SA | Vmax 6202, | Vertex 90SA | 25:75, 8% | 90SA | Vmax 6202, |
| | | | 20% | | Vmax 6202 | | 35% Vertex |
| | | | Vertex 90SA | | 20% | | 90SA |
| | | | | | Vertex | | |
| | | | | | 90SA | | |
| Tensile | 9,640 | 9,200 | 7,910 | 8,980 | 7,350 | 9,410 | 6,940 |
| Strength | | | | | | | |
| (ASTM) psi | | | | | | | |
| Elongation at | 16.3 | 29.7 | 26.4 | 31.7 | 19.7 | 7.9 | 7.6 |
| Break | | | | | | | |
| (ASTM) % | | | | | | | |
| Modulus of | 371,000 | 376,000 | 325,000 | 370,000 | 296,000 | 520,000 | 394,000 |
| Elasticity | | | | | | | |
| (ASTM) psi | | | | | | | |
| Notched Izod | 1.19 | 1.70 | 1.64 | 1.86 | 1.95 | 1.14 | 1.25 |
| Impact Test | | | | | | | |
| ft-lb/in | | | | | | | |
| Specific | | | | 1.37 | | | 1.42 |
| gravity | | | | | | | |
| Ash content | 19.28 | 18.8 | 19.3 | 20.1 | 20.24 | 33.6 | 36.43 |
| % | | | | | | | |
| Lbs packed | 520 | 50 | 50 | 50 | 25 | 520 | 20 |
| | short burn | 3 had burn | short burn | 3 of 5 had | short burn | short burn | short burn |
| | time, all | Time >30 sec, | time, all | burn time | time, all | time, all | time 2 of 5 |
| | samples | all samples | samples | >30 sec, no | samples | samples | dripped |
| | dripped | dripped | dripped | dripping | dripped | dripped | |
| Flame | V-2 | V-2 | V-2 | V-1 | V-2 | V-2 | V-2 |
| Performance, | | | | | | | |
| UL94 rating | | | | | | | |

Review of the data presented in Table 1 shows that Vistamaxx 6202 did not add any benefit to mechanical results and seemed to reduce the flame resistance or self-extinguishing properties. No further tests were conducted with Vistamaxx 6202.

Trial 2 in the table above was conducted at 1500 lb and was produced for preliminary assessment for suitability as a molding resin. With the data from the table, the interest turned to producing a polyketone composition with as low weight a percent loading of Mg(OH)2 as possible to achieve at least a V-2 flame rating and as high a mechanical property as possible. Further, results indicated that if Poketone M330F could be removed from the composition, a further increase in mechanical performance may be achieved.

Materials assigned a ‘V’ rating, using UL classifications, are deemed to be self-extinguishing (see UL Rating Table at the bottom of this report). A V-1 rating is assigned to materials that self-extinguish in 30 seconds or less and which do not drip flaming particles. For reference, as shown in the UL Rating Table, the following ranking progresses from lowest level of self-extinguishing performance to highest level: V-2<V-1<V-0<5VB<5VA. An HB rated material is considered one that is not self-extinguishing.

UL Rating Table

| | Orientation of | | Time of Burn | Particle Drop Allowed | | Plaque |
|---|---|---|---|---|---|---|
| Class | Test Sample | Definition | Allowed | Flaming | Non-Flaming | Holes |
| UL 94 HB | Horizontal | Slow Burning | Burning rate of less than 76 mm/min for a specimen less | | | |
| | | | than 3 mm thick and burning stops before 100 mm | | | |
| UL 94 V-2 | Vertical | Burning Stops | 30 seconds | Yes | Yes | |
| UL 94 V-1 | Vertical | Burning Stops | 30 seconds | No | Yes | |
| UL 94 V-0 | Vertical | Burning Stops | 10 seconds | No | Yes | |
| UL 94 5VB | Vertical | Burning Stops | 60 seconds | No | No | Yes |
| UL 94 5VA | Vertical | Burning Stops | 60 seconds | No | No | No |

### Example 2: Enhanced Compositions

Enhanced compositions were prepared. Table 3 shows the weight % of the materials used. The designations in Table 3 include a 4-digit number, for example 0100 or 1585 or 2575. These 4-digit numbers describe the ratio of Poketone M330F to Poketone M630F, on a resin/resin basis. Therefore, the designation 0100 indicates 0% Poketone M330F and 100% Poketone M630F and the designation 2575 indicates 25% M330F and 75% M630F, totaling: 100%. In the designation 2575 composition that contains 18% Mg(OH)2 and 82% polyketone resin, 75% of the 82% polymer is Poketone M630 or 61.5% by weight and 25% of the 82% total polymer is Poketone M330F or 20.5% by weight. The seven (7) test runs shown in Table 3 were 25 lb each. Mechanical data from these test runs are shown in Table 4.

### Tables 3 and 4: Improved Compositions and Mechanical Data

TABLE 3

| | -NA-1008 | -NA-1010 | -NA-1012 | -NA-1012 | -NA-1015 | -NA-1015 | -NA-1018 |
|---|---|---|---|---|---|---|---|
| | POK9000- | POK9000- | POK9000- | POK9000- | POK9000- | POK9000- | POK9000- |
| | 0100 | 0100 | 0100 | 1090 | 0100 | 1585 | 2575 |
| M630F | 92 | 90 | 88 | 79.2 | 85 | 72.25 | 61.5 |
| Vertex90SA | 8 | 10 | 12 | 12 | 15 | 15 | 18 |
| M330F | | | | 8.8 | | 12.75 | 20.5 |
| Total | 100 | 100 | 100 | 100 | 100 | 100 | 100 |

TABLE 4

| Lot# | A-232239-1 | A-232239-2 | A-232239-3 | A-232239-5 | A-232239-4 | A-232239-6 | A-232239-7 |
|---|---|---|---|---|---|---|---|
| Tensile | 9630 | 9570 | 9450 | 9490 | 9300 | 9450 | 9670 |
| Strength | | | | | | | |
| Elongation | 47.2 | 33.1 | 37.1 | 35.1 | 31.5 | 33.2 | 28.2 |
| at break | | | | | | | |
| Tensile | 367000 | 367000 | 360000 | 370000 | 361000 | 367000 | 408000 |
| Modulus | | | | | | | |
| Notched | 1.76 | 1.74 | 1.77 | 1.68 | 1.75 | 1.64 | 1.48 |
| Izod | | | | | | | |
| Specific | 1.29 | 1.30 | 1.31 | 1.31 | 1.33 | 1.33 | 1.35 |
| Gravity | | | | | | | |
| % Ash | 7.4 | 9.3 | 11.1 | 11.9 | 15.2 | 15.3 | 17.8 |
| UL-94 | | | | | | | |
| 3mm | | | | | | | |

What is claimed is:

1. A conveyor component made of a self-extinguishing aliphatic polyketone composition suitable for direct or indirect contact with food comprising: about 80.0 wt. % to about 95.0 wt. % of an aliphatic polyketone polymer resin and from about 5.0 wt. % to about 20.0 wt. % of an amino-silane surface-modified magnesium hydroxide.

2. The conveyor component of claim 1, wherein the aliphatic polyketone polymer resin comprises from about 75.0 wt. % to about 100.0 wt. % of a high molecular-weight aliphatic polyketone polymer resin and about 0.0 wt. % to about 25.0 wt. % of a low molecular-weight aliphatic polyketone resin.

3. The conveyor component of claim 1, wherein the amino-silane surface-modified magnesium hydroxide comprises an average particle size of about 1.5 microns or less.

4. The conveyor component of claim 1, wherein the composition comprises a V-2 flame performance by a plastic flammability standard.

5. The conveyor component of claim 1, wherein the composition comprises a tensile strength ranging from about 9,200 pounds per square inch (psi) to about 9,700 psi.

6. The conveyor component of claim 1, wherein the composition comprises an elongation at break ranging from about 33% to about 48%.

7. The conveyor component of claim 1, wherein the composition comprises a tensile modulus ranging from about 360,000 psi to about 370,000 psi.

8. The conveyor component of claim 1, wherein the composition comprises a notched Izod impact test ranging from about 1.60 ft-lb/in to 1.80 ft-lb/in.

9. The conveyor component of claim 1, wherein the composition comprises a specific gravity ranging from about 1.28 to about 1.36.

10. The conveyor component of claim 1, wherein the composition has an ash content ranging from about 7.0% to about 18.0% after the composition is heated to about 500° C. or greater to burn off the polyketone polymer from the composition.

11. The conveyor component of claim 1, wherein the composition exhibits an inverse synergistic effect between a melt viscosity and a minimum amount of amino-silane surface-modified magnesium hydroxide to provide the composition with a self-extinguishing performance.

12. The conveyor component of claim 1 made by injection molding.

13. The conveyor component of claim 1 made by extrusion.

14. The conveyor component of claim 1 wherein the conveyor component is selected from the group consisting of: a conveyor belt module, a return roller, a sprocket, a saddle for supporting the end of a shaft, a wearstrip element, and a hinge rod.
